(19) United States
(12) Patent Application Publication
(10) Pub. No.: US 2023/0230712 A1
(43) Pub. Date: Jul. 20, 2023

(54) LIGHT WATER NUCLEAR REACTOR (LWR), IN PARTICULAR PRESSURIZED WATER REACTOR (PWR) OR BOILING WATER REACTOR (BWR), WITH A HEAT SINK ON THE GROUND AND INCORPORATING AN AUTONOMOUS DECAY HEAT REMOVAL (DHR) SYSTEM

(71) Applicant: COMMISSARIAT A L'ENERGIE ATOMIQUE ET AUX ENERGIES ALTERNATIVES, Paris (FR)

(72) Inventors: Guillaume LHERMET, Grenoble Cedex (FR); Nadia CANEY, Grenoble Cedex (FR); Franck MORIN, Saint Paul Lez Durance (FR); Nicolas TAUVERON, Grenoble Cedex (FR)

(73) Assignee: COMMISSARIAT A L'ENERGIE ATOMIQUE ET AUX ENERGIES ALTERNATIVES, Paris (FR)

(21) Appl. No.: 18/156,629

(22) Filed: Jan. 19, 2023

(30) Foreign Application Priority Data
Jan. 19, 2022 (FR) 22 00436

(51) Int. Cl. G21C 1/32; G21C 15/253

(52) U.S. Cl. CPC G21C 1/324; G21C 15/253

(57) ABSTRACT

An ORC engine and an additional water reservoir, separate from the pool, the energy stored in the pool being the heat source for the evaporator of the ORC, the additional water reservoir directly supplying the condenser of the ORC via a dedicated pump in order to constitute the heat sink for the condenser of the ORC.

### TECHNICAL FIELD

The present invention concerns the field of nuclear reactors, in particular pressurized water and boiling water nuclear reactors.

More particularly, the invention relates to an improvement of the function of removing the decay heat of these nuclear reactors in an accident situation. It aims to integrate an autonomous decay heat removal (DHR) system into the backup systems of advanced light water reactors (LWRs).

It is thus an object of the invention to overcome a major drawback of the passive safety condensers, or passive wall condensers, according to the prior art, which resides in the need to provide very large volumes of water at height, which burdens and complicates the civil engineering of a nuclear plant, which is a great constraint particularly in respect of the problem of earthquakes, and increases the cost.

The second advantage of the invention consists in obtaining a better overall performance of this type of system because of the forced convection of the circuit containing the safety condenser, together with a more compact exchanger because of the better heat exchange performance, and therefore a smaller overall volume of the system.

It may be recalled here that the decay heat of a nuclear reactor is the heat produced by the core following shutdown of the nuclear chain reaction, consisting of the decay energy of the fission products.

Although described with reference to a pressurized water nuclear reactor, the invention applies to a boiling water nuclear reactor or any light water nuclear reactor (LWR) in which the safety means for removing the decay heat, although currently envisioned, require the provision of large quantities of water at height as a heat sink.

### PRIOR ART

A pressurized water nuclear reactor (PWR) comprises three cycles (fluidic circuits), the general normal operating principle of which is as follows.

The water at high pressure of a primary circuit withdraws the energy provided in the form of heat by the fission of uranium nuclei and possibly plutonium nuclei in the core of the reactor.

This water at high pressure and high temperature, typically 155 bar and 300° C., then enters a steam generator (SG) and transmits its energy to a secondary circuit, which itself also uses pressurized water as a heat transfer fluid. This water in the form of steam at high pressure, typically about 70 bar, is then expanded via a pressure reduction member converting the variation in enthalpy of the fluid into mechanical then electrical work in the presence of an electrical generator.

The water of the secondary circuit is then condensed via a condenser using a third cycle, the cooling cycle, as a heat sink.

Unlike a PWR, a boiling water reactor BWR does not have a steam generator: it comprises a single circuit for water and steam produced after evaporation in the vessel. The cooling water is partially vaporized in the core. This water flows under pressure, but at a pressure less than that of a PWR, typically from 70 to 80 bar.

Reference may be made to FIG. 2 of publication [1], which illustrates the overall configuration of a BWR. The water taken off from the condenser is pumped via main pumps to the pressure of the reactor vessel and admitted therein at the periphery of the core. It is then mixed and heated by a large flow rate of saturated water coming from the separation of the steam-water emulsion produced in the core. At the exit of the core, the water-steam mixture is separated by gravity and centrifuging. The steam produced is directed to steam collectors and turbines downstream, while the saturated water is for its part recirculated in order to be mixed with the cooler water. The water mixture descends along the vessel wall, where it is taken up through primary loops external to the vessel by primary pumps in order to be directed into the core and subsequently passes through the core, where the heat produced is extracted, which causes heating to saturation and evaporation.

A BWR comprises safety condensers, also referred to as “isolation condensers”: they constitute the final resort for the auxiliary cooling of the reactor core. A schematic illustration of the arrangement of an “isolation condenser” is given in FIG. 4 of publication [1].

However, although the operation of light water reactors (LWRs) is known, mastered and reliable, the history of nuclear power, particularly with the Fukushima-Daiichi accident in 2011, has shown weaknesses in the management of stations in the event of extreme accident situations with a prolonged loss of voltage of the electricity network, aggravated by the loss of the internal electrical production means and the heat sink as well.

This accident situation is due in particular to a fault in removing the decay heat of the reactors. These accident sequences were also encountered for the fuel cooling pools during the Fukushima accident in 2011.

The decay heat phenomenon of the core of the reactor is manifested in the following way.

During the shutdown of the nuclear reaction, the fission products undergoing decay continue to produce heat until reaching a stable state.

One second after the shutdown of the reactor, this heat represents 7% of the rated thermal power of the reactor.

It then decreases with time as represented in FIG. 1, which is taken from publication [2].

For example, 72 hours after the shutdown of the reactor, it still represents 0.5% of the rated thermal power. It is therefore essential to remove this heat in order to avoid any risk of degradation or even meltdown of the fuel of the core.

By way of example, the PWR known by the name VVER TOI has a rated electrical power of 1300 MWe and a rated thermal power of about 3200 MWth. 72 h after its shutdown, this reactor still produces a residual thermal power of about 20 MWth.

Generally, in order to remove the decay heat, attempts are constantly being made to improve the passivity and the diversity of the systems in order to ensure better overall reliability. The aim is to maintain the integrity of the structures, namely the first (cladding of the fuel assemblies) and second containment barrier (primary circuit), and third barrier (containment building), and to do so even in the event of a generalized absence of electrical voltage over a long period of time, which corresponds to a scenario of the Fukushima type.

More particularly, since the Fukushima accident much research has been focusing on technologies for removing the decay heat passively over durations of several tens of hours.

The requirements for the new solutions relate above all to an improvement in performance and their reliability, as well as the greatest possible operating autonomy, at least 72 hours, before any intervention by humans and external physical means.

More critically, in the scope of the invention an accident situation is considered with prolonged interruption, typically for several days, of the electrical supplies for whatever reason, without supply by batteries. Such a situation is known by the name “Station BlackOut” (acronym SBO).

One of the effective ways of extracting the decay heat of the core of a PWR in an accident situation without active means which need electricity is to cool the core of the reactor via a passive system while transmitting its thermal energy either to the atmosphere via an air exchanger or to a reservoir (pool) of water placed at height, in order to ensure natural convection. Such a system is referred to by the name “passive residual heat removal” (PRHR).

A PRHR has the same structure overall, whether for air cooling or water cooling: a cooling circuit is arranged at the exit of the steam generator (SG) of the PWR. Thus, instead of sending the steam of the secondary circuit into the turbine, the steam is sent into a parallel circuit where it is cooled and condensed, either by an air condenser or by a water condenser.

A first natural circulation loop makes it possible to transfer the thermal energy of the core to the SG, then a second loop does so from the SG to a condenser. Thus, the removal of the decay heat emitted by the core of the reactor is carried out by means of the SG and the two natural circulation loops, which are therefore passive.

An example of an air condenser as an already implemented PRHR is that of the VVER TOI PWR, the thermal and electrical powers of which have been mentioned above: the air condenser is in the form of a single-tube exchanger with circular fins, configured overall as a coil.

The advantages of an air condenser such as this one reside in the fact that air is a heat sink which is inexhaustible (in an open environment) and is naturally present. This air condenser technology is therefore entirely independent of the cooling duration, and there is no phenomenon of progressive heat sink loss.

The major drawback of this technology is the volume of air exchangers. This is because since the coefficients of heat exchange with air are low, the required volumes and surfaces of air exchangers are very great, and the heat extraction performance is highly dependent on the weather conditions.

For example, the PRHR of the VVER TOI is dimensioned in order to be able to take out a decay heat equal to 2% of the rated thermal power of the reactor, that is to say a power of 64 MWth. In order to achieve such a power, it was necessary to install a number of 16 units with an exchange surface equivalent to several thousands of square meters, which are located in the upper part of the nuclear plant.

As mentioned above, the removal of the decay heat which is necessary in order to carry out the cooling of the core of a PWR may be carried out by a water condenser, as illustrated schematically in FIG. 2. The core of the reactor 1 is connected to a steam generator (SG) 2 and the decay heat is removed by a closed loop with passive natural circulation 3, which comprises the SG with a water condenser 4 immersed in a water reservoir or pool 5 placed at height. Thus, this loop 3 makes it possible to transmit the thermal energy of the SG to the water reservoir 5. During the removal of the decay heat, this reservoir 5 rises in temperature until the water boils. The water evaporates into the air at atmospheric pressure with a certain kinetic behavior.

Many current projects use water as the heat sink of the PRHR, among which the following may be mentioned in particular:
the projects AP-600 and AP-1000 of the US company Westinghouse;
the project Hualong-1 of the Chinese companies China General Nuclear Power Corporation (CGNPC) and the China National Nuclear Corporation (CNNC);
the project VVER1200 of the Russian company ROSATOM, in the version of passive safety condensers with water in the heat sink.

This decay heat removal system has major drawbacks.

First, the presence of a source of water at height complicates and burdens the civil engineering because of the need to maintain an intact structure for this safety heat sink in case of extreme external events such as a major earthquake or collision by an aircraft.

Furthermore, the cooling time of the steam generator is directly linked with the volume of the pool by the effect of evaporation of the water: the greater the volume of water is, the longer the cooling duration is. By way of example, the reactor HPR1000 with a rated thermal power of 3060 MW comprises a PRHR whose dimensioning has been designed to allow cooling for 72 h, which means a pool volume of 2300 m³: [3].

Thus, the problem with this system resides in a necessary compromise between the civil engineering constraints of the pool and the cooling duration ensured, typically at least 72 h.

One beneficial configuration of emergency cooling of a steam generator (SG-ECS, “Steam Generator Emergency Cooling System”) has already been proposed for the reactor project VVER TOI, particularly in publication [4]. This configuration is illustrated schematically in FIG. 3. The pool 5 is arranged on the ground and the SG-ECS comprises three closed-loop cooling circuits in series:
the first comprises the steam generator 2, a first water pump 30 (steam condensates of the secondary circuit) and a fluid circuit of a first liquid/liquid exchanger 31;
the second comprises the other fluid circuit of the first exchanger 31, a second water pump 32 and a fluid circuit of a second liquid/liquid exchanger 33,
the third comprises the other fluid circuit of the second exchanger 33, a third water pump 34 and the pool 5.

This safety system is effective and autonomous but not passive: the flow of the secondary fluid takes place non-gravitationally from the steam generator 2 to the intermediate exchanger 31. The heat transfer between the steam generator 2 and the heat sink on the ground takes place using the pumps 30, 32, 34 and using the intermediate exchangers 31 and 33. Thus, this system requires fairly significant external energy input in order to electrically supply the three pumps 30, 32, 34 used. This energy input for electrically supplying the pumps 30, 32, 34 is carried out by auxiliary internal combustion engines or optionally gas turbines.

There is exactly the same problem for removing the decay heat of a boiling water reactor (BWR), which in particular did lead to meltdown of the core of several units of the Fukushima Daiichi station. In that case, it is no longer steam coming from the secondary circuit of a steam generator (SG) but directly steam coming from the reactor vessel which it is necessary to cool and condense in order to remove the decay heat of the core. The heat sink required for the condensation of the primary steam and its cooling then need to be at height with respect to the core of the reactor, and in a large volume. The dimensioning of this heat sink, in the case of the boiling water reactors involved in the Fukushima disaster, did not make it possible to achieve passive operating autonomies of 72 hours, as is usually desired currently.

Depending on the accident procedures in place, it may also be the containment building cooling and depressurization system of the pressurized or boiling water reactor which is then used as the final means for removing the decay heat, particularly in the case of a primary circuit opened intentionally (so-called “stuck-open” configuration in the ultimate scenario) or not (situation of primary coolant loss due to an accident of the primary breach type). The ultimate heat sink then describes the one dedicated to removing the decay heat associated with such a cooling means.

In both situations mentioned above, these two types of passive safety condensers can operate over a long period only on condition that a heat sink with water in a sufficient quantity makes it possible to absorb the thermal power necessary for cooling the reactor core.

Similarly as for the application relating to pressurized water reactors, this heat sink must be located at height relative to the combination formed by the reactor vessel and its containment building, in order to establish natural circulation making it possible to remove the decay heat from the core of the reactor or the center of the containment building.

In general, the natural circulation of a single-phase or two-phase fluid is possible so long as the heat sink increasing the density of the fluid is located at a higher level than the heat source lowering the density of the same fluid. In the converse case, there is thermal stratification and blocking of the natural circulation.

Thus, an autonomous device providing a heat sink would make it possible to extend the operating autonomy of this type of safety system considerably compared with operation for a few hours because of constraints due to restrictions of the volume of water at height.

By way of illustration, FIG. 2 of publication [5] gives an idea of the required volumes of heat sink at height which are dedicated to the operation of the passive containment cooling system (PCCS) on the one hand, dedicated to the ultimate removal, and of the water condenser (“isolation condenser”) on the other hand, dedicated to the safety removal.

It has already been envisioned to use an “Organic Rankine Cycle” (ORC) engine as a supplement to a cooling system of a pressurized water reactor (PWR) in an accident situation.

As explained above, the problem with water PRHRs resides in the relationship between the volume of the pool and the cooling time.

Thus, one solution to this problem consists in taking out a part of the energy accumulated in the pool via an exchanger. This exchanger is then used as the evaporator of an ORC. The condenser of the ORC is an air condenser (aerocondenser).

This solution makes it possible to use the power produced by the turbine of the ORC via the turbine-generator coupling in order to supply the pump of the ORC, which creates an autonomous system making it possible to remove a part of the heat stored in the pool.

Such an ORC therefore makes it possible to recover a part of the energy stored in the form of heat in the pool, and to remove/recycle it in a dedicated circuit, and therefore to limit the quantity of water evaporated by the pool, and thus to extend the duration of cooling by the pool.

For instance, patent application WO2012/145406 has proposed such a solution but for a different application field. Specifically, the thermal energy which is added into the pool, originating from spent nuclear fuels, still produces heat. Thus, when applied to a PWR, this technology makes it possible to overcome certain problems explained above. This is because a part of the thermal energy stored in the pool can be taken out by an ORC, which makes it possible to extend the time of removal of the decay heat of the core for a given pool volume.

Although making it possible to improve the ratio between the cooling duration and the volume of the pool, however, the efficiency of this technology is dependent on the volumes of the exchangers which make it possible to remove the power to the ultimate heat sink (air). Specifically, in order for this system to be truly functional throughout the cooling period of a PWR, it will be necessary for the power extracted by the exchanger of the cooling cycle of the pool to be of the same order of magnitude as the power exchanged between the pool and the reactor.

Now, as explained above, in the case of the VVER TOI reactor the decay heat of the reactor is of the order of several tens of MW.

Thus, implementing an ORC as proposed in the aforementioned application, taking out all or at least most of the power exchanged between the pool and the reactor, would require colossal installation volumes, especially for the final air exchanger.

In other words, although making it possible to extract the decay heat of the core of the reactor for a given time which is longer than without an ORC, the system proposed in patent application WO2012/145406 is still of very limited actual use and truly effective for decay heats of about one hundred kW.

Patent application WO2013/019589 proposes a similar solution, namely cooling spent nuclear fuels by immersing them in a water reservoir and using the thermal energy of this water reservoir to operate an ORC or a Stirling cycle. This patent application furthermore proposes adding a thermoelectric module which uses the heat produced by the spent fuel in order to convert it into electricity.

The originality of the solution according to WO2013/019589 resides in the use of the electricity produced by these various systems as a complement to the thermal energy obtained from the pool, by implementing two water pumps, one of which directs the water to the reservoir (pool) level with a fan placed at height, in order to cool it, and the other of which pumps water from another water reservoir in order to overcome the evaporation of the water of the pool.

Thus, by virtue of these water pumps, there is no direct link between the cooling duration and the pool volume since a dedicated pump allows constant addition of water to the pool.

However, the solution according to WO2013/019589 has several drawbacks.

First, the exchangers of the heat sink of the Stirling cycle or of the ORC are air exchangers and therefore, as explained above, these exchangers may have a very large volume and are necessarily located in the upper part.

Furthermore, air exchangers have the characteristic of depending greatly on the external temperature and therefore on its variability. In order to ensure their reliability, it is therefore necessary that the system can adapt to the temperature variations of the geographical region of the station.

There is therefore a need to improve the decay heat removal (DHR) systems of light water nuclear reactors (LWRs), in particular pressurized (PWR) or boiling water (BWR) nuclear reactors, requiring devices for decay heat removal over long periods, in order to overcome the aforementioned drawbacks by using an ORC engine (cycle).

### SUMMARY OF THE INVENTION

In order to do this, the invention relates, according to one of its aspects, to a light water nuclear reactor (LWR), in particular a pressurized water reactor (PWR) or a boiling water reactor (BWR), comprising:
a reactor core;
a cooling circuit comprising a heat exchange means connected in a closed loop to a means for taking off steam from the primary or secondary circuit of the reactor and a first pump for supplying the means of the primary or secondary circuit with water from the heat exchange means;
a system for removing at least a part of the decay heat of the reactor core, the system comprising:
   a first water reservoir or pool, arranged below the steam generator, in which the heat exchange means is immersed so that the water contained therein cools the steam coming from the take-off means;
   an organic Rankine cycle (ORC) engine comprising:
      an expander,
      a condenser,
      a second pump,
      an evaporator arranged in contact with the pool so that the latter constitutes the heat source of the ORC,
      a fluidic circuit in which a working fluid flows in a closed loop, the fluidic circuit connecting the expander to the condenser, the condenser to the second pump, the second pump to the evaporator, and the evaporator to the expander;
   a second water reservoir, separate from the pool, and a third pump connected to the second water reservoir and to the condenser of the ORC in order to supply the latter with water, as the heat sink of the ORC.

The first water reservoir or pool contains a large volume of water, in particular greater than or equal to 50 m³ and/or less than or equal to 100 m³.

For a pressurized water nuclear reactor (PWR), according to a first embodiment, the PWR comprises a cooling circuit comprising a steam generator and a water condenser immersed in the pool and connected in a closed loop to the steam generator.

For a pressurized water nuclear reactor (PWR), according to a second embodiment, the means for withdrawing the decay heat present in the primary circuit is a liquid/liquid exchanger, and the heat exchange means is a water exchanger immersed in the pool, so that the water contained in the latter cools the water of the primary circuit flowing in the liquid/liquid exchanger.

For a boiling water nuclear reactor (BWR), according to a first embodiment, the BWR comprises a cooling circuit comprising:
a take-off of primary steam from the supply line to the turbine of the reactor;
a water condenser immersed in the pool and connected in a closed loop to the steam take-off.

For a pressurized water nuclear reactor (PWR) or a boiling water nuclear reactor (BWR), according to another embodiment, the means for removing the decay heat coming from the core of the reactor may be a system for depressurizing the steam present in the containment building, and the heat exchange means may be a water exchanger immersed in the pool or a direct take-off of the water of the pool on the one hand, and on the other hand a containment wall condenser in direct contact with the steam present in the containment building of the reactor.

Advantageously, the first water reservoir or pool is arranged on or in the ground.

Also advantageously, the second water reservoir is arranged in a part lower than the pool, advantageously on or in the ground.

The evaporator of the ORC may be immersed in the pool or remote therefrom.

Preferably, the immersed evaporator is a tube exchanger or a plate exchanger.

According to one advantageous embodiment, the reactor furthermore comprises a refrigeration cycle comprising:
a compressor;
a condenser connected to the second pump in order to supply the latter with water;
a pressure reduction member;
an air evaporator;
a fluidic circuit in which a working fluid flows in a closed loop, the fluidic circuit connecting the compressor to the condenser, the condenser to the pressure reduction member, the pressure reduction member to the air evaporator, and the air evaporator to the compressor.

Advantageously, the condenser of the refrigeration cycle is the condenser of the ORC.

Also advantageously, the working fluid of the refrigeration cycle is that of the ORC.

According to one advantageous alternative embodiment, the shaft of the ORC expander is coupled to the shaft of the compressor of the refrigeration cycle.

Preferably, the reactor comprises batteries configured for the electrical start-up of the second pump intended to provide the ORC condenser with a heat sink, of the electrical components of the ORC, and optionally of the refrigeration cycle. Preferably, the reactor comprises batteries intended for the operation of the first pump in order to fulfill the function of removing the decay heat during the period preceding the start-up of the ORC.

Thus, the invention firstly implements a safety condenser system using, as a heat sink, a water reservoir or pool in which the condenser is immersed and which is arranged below the core of the reactor, preferably on the ground.

Here and in the context of the invention, the term “on the ground” is intended to mean a pool which is buried or “above ground”, which is supported on the ground.

This pool makes it possible to remove the decay heat of the core of the reactor.

Now, as explained in the preamble, this architecture is dependent on the volume of the pool: the cooling time of the pool is proportional (or directly linked) to its volume, and is therefore limited.

In order to overcome this, the invention essentially consists in installing an ORC engine and an additional water reservoir, separate from the pool, the energy stored in the pool being the heat source for the ORC evaporator, the additional water reservoir supplying the condenser of the ORC directly through a dedicated pump in order to constitute the heat sink for the condenser of the ORC.

In this way, the losses of water by evaporation of the pool are compensated for by conveying water from the additional reservoir, advantageously in a lower part, preferably at ground level.

One major advantage of arranging the heat sink from the ground is the very great simplification of the civil engineering dedicated to supporting and protecting this safety heat sink volume in the upper part of the nuclear plant, and the reduction in construction and maintenance cost, and the earthquake resistance studies, which result therefrom.

The fact of having the pool on the ground allows it to be given a large volume because there is no significant civil engineering to be provided, and therefore makes it possible to have a large heat sink for the ORC engine. This is because positioning the pool on the ground allows direct heat sink provisioning without having to implement a pumping system which takes the water to a height.

The use of the first pump in order to convey the condensed secondary water from the pool to the ground entails an increase in the electrical power to be produced compared with a configuration in which the pool is at height. However, the presence of this sizeable heat sink on the ground, coupled with a heat source which is also sizeable, makes it possible to produce electrical powers very much sufficient for these situations.

Although not passive in the strict sense of the term because of the presence of the water circulation pumps and the expander (turbine), the safety secondary cooling in a closed cycle according to the invention presents the major advantage of performing much better than a passive system using a natural two-phase flow from the steam generator (PWR) or the steam take-off line (BWR).

Furthermore, the system according to the invention may be easily regulatable by controlling the power of the first pump, which sends the secondary condensates to the steam generator (PWR) or the primary condensates to the reactor vessel (BWR). This thus makes it possible for an operator of a nuclear plant, who integrates a system according to the invention, to be able to manage the cooling gradient per hour of the reactor, which is desirable for incident phases liable to recur several times in the lifetime of the nuclear unit, or even for normal cooling phases of the reactor.

The decay heat removal system according to the invention differs from the systems according to the prior art, in particular by the following aspects:
unlike the existing systems which use air as a heat sink, the water conducted from the lower part out of the additional water reservoir is used as a heat sink for the condenser of the ORC;
the possibility of having a very sizeable heat sink because of the possible position of the pool and the additional water reservoir on the ground;
this water conveyed from the additional water reservoir may advantageously also be used as a heat sink for the condenser of a refrigeration cycle, the aim of which is to produce the cooling power, for example for cooling the expander of the ORC, and therefore ensuring a better autonomy and reliability of the system, or alternatively for cooling other safety equipment, for example an electrical or control cabinet, a control room, etc.

One major advantage of a system configuration according to the invention, in comparison with the geometries of existing systems, is therefore the use of the water conveyed in order to supply the pool during evaporation as a heat sink for the condenser of the ORC, and advantageously of a refrigeration cycle.

Thus, a configuration of a system according to the invention makes it possible to implement a plate water exchanger as an evaporator of the ORC, which must in fact be remote from the pool but whose volume is much less than that of air condensers with an equivalent power. By way of indicative example, a plate water exchanger has a convective exchange coefficient improved by a factor of from 50 to 100 relative to a condenser in which the fluid is air.

The use of a water exchanger makes it possible to reduce the condensation pressure of the ORC fluid in the ORC, and the efficiency is therefore increased.

The fact of using pumped water as a heat sink of the ORC, and advantageously of the refrigeration cycle which is combined, additionally makes it possible to greatly increase the reliability of the system: reducing the volumes of the exchangers makes them less vulnerable to external events, whether natural or malicious.

Furthermore, water/water plate condensers are widely known exchangers of the prior art having a high reliability (which is an essential criterion in the field of nuclear power).

Also, the fact that the heat sink of all the exchangers of the heat sink (cooling cycle of the reactor, ORC, refrigeration cycle) is water avoids the use of a complementary heat sink, in the prior art air.

As explained above, an air exchanger is extremely dependent on the temperature of the ambient air. Thus, using the water of a reservoir placed in the lower part as a heat sink of the ORC makes it possible to be less dependent on the external temperature, and therefore its variations.

With the invention, in fact, there is no longer a power limitation due to the heat sink of the cycle. This is because the size of the water exchanger and the temperature conditions on the heat sink side are no longer as limiting as with an air condenser according to the prior art, the size of which is desired to be minimized, without mentioning the aforesaid temperature of the air.

The invention therefore makes it possible to produce a high electrical power, and therefore allows the possibility of cooling and condensing large quantities of secondary steam of a PWR or primary steam of a BWR with small installation volumes.

The addition of a refrigeration cycle to the ORC, according to the invention, makes it possible to cool the expander of the ORC as well as other components, for example the power electronics to be cooled, and therefore to increase the autonomy and reliability of the system. A single condenser may advantageously be used in common for the ORC and for the refrigeration cycle, which is possible with working fluid flows which are fluidically either in series or in parallel.

The extra electricity due to the ORC according to the invention can cover not only the requirements described above but also other safety electrical requirements of the plant, such as the electrical supply of the control or measuring devices, cooling devices, etc.

The system according to the invention entails the implementation of batteries necessary for starting up the system. These batteries are used in particular for starting up the pump dedicated to the return of the primary or secondary condensates to the steam generator (PWR) or the steam take-off (BWR). The energy accumulated in these batteries may be very limited, multiple redundant groups making it possible to ensure a high reliability.

Overall, a nuclear reactor with a system according to the invention has numerous advantages, among which the following may be mentioned:
significant improvement of the existing cooling system of a nuclear reactor, in particular that of a PWR comprising a steam generator, a closed-loop natural convection circuit and a cooling pool;
reliable and autonomous system;
possibility of having a nuclear plant with small volumes in the upper part, which alleviates the constraints of civil engineering and cost;
possibility of managing the cooling gradient of the reactor by modifying the pump speed for raising the secondary PWR condensates or primary BWR condensates.

Other advantages and characteristics of the invention will become more apparent upon reading the detailed description of exemplary embodiments of the invention, which is given by way of illustration and without limitation with reference to the following figures.

### BRIEF DESCRIPTION OF THE DRAWINGS

FIG. 1 illustrates in the form of a curve the decrease as a function of time of the decay heat of a nuclear reactor according to the prior art, known by the designation VVER TOI.

FIG. 2 is a schematic view of a passive system for removing the decay heat of a nuclear reactor core of the PWR type according to the prior art.

FIG. 3 is a schematic view of a nuclear reactor of the PWR type with a water pool on the ground and a passive system and for removing the decay heat of a reactor core according to the prior art.

FIG. 4 is a schematic view of a nuclear reactor of the PWR type with a water pool on the ground and a passive system and for removing the decay heat of a reactor core according to the invention.

FIG. 5 is a schematic view illustrating one embodiment of the invention furthermore comprising a refrigeration cycle.

FIG. 6 is a T-s entropy diagram of the ORC and of the refrigeration cycle of a system such as according to FIG. 5.

FIG. 7 is a schematic view illustrating a first variant of a system according to the invention.

FIG. 8 is a view illustrating a second variant of a system according to the invention.

FIG. 9 is a schematic view illustrating another embodiment according to the invention with a system for depressurizing the steam present in the containment building of a BWR or PWR.

FIG. 10 is a schematic view illustrating a first variant of a heat exchange means according to the invention for a BWR or PWR.

FIG. 11 is a schematic view illustrating a first variant of a heat exchange means according to the invention for a BWR or PWR.

### DETAILED DESCRIPTION

Throughout the present application, the terms “vertical”, “lower”, “upper”, “down”, “up”, “below” and “above” are to be understood by reference with respect to a water-filled cooling pool of a nuclear reactor, such as is in a horizontal operating configuration and arranged on the ground, that is to say buried or “above ground”, supported on the ground.

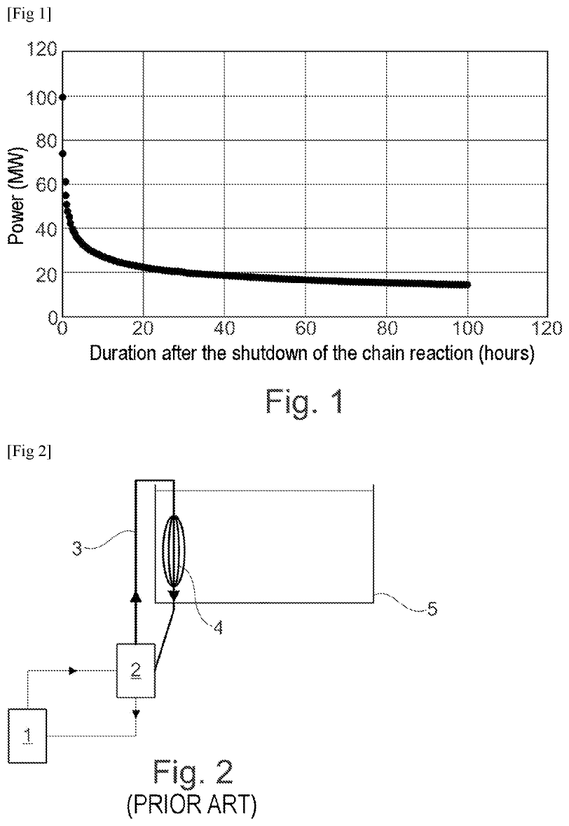

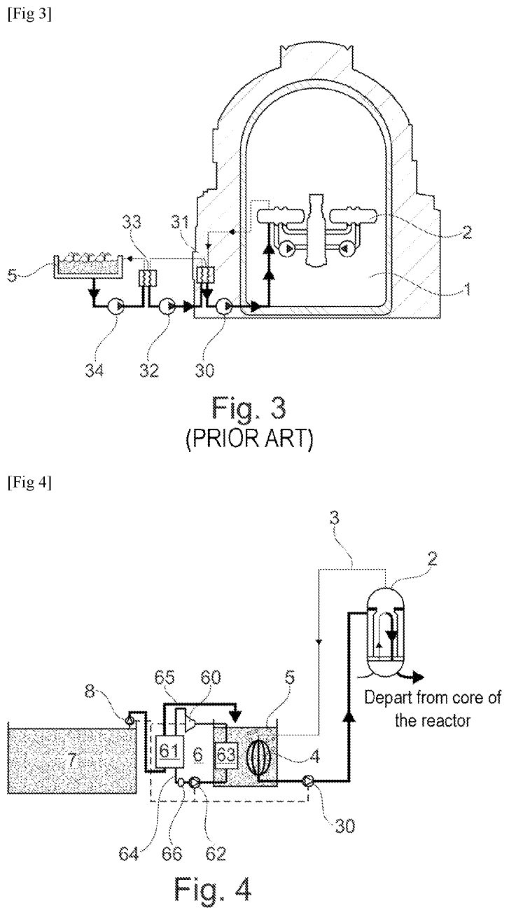

FIGS. 1 to 3 have already been described in detail in the preamble, and will therefore not be discussed below.

For the sake of clarity, a given element according to the invention and according to the prior art will be denoted by the same numerical reference in all of FIGS. 1 to 8.

It is to be pointed out that in FIGS. 4 to 8, which relate to the invention, only a part of the cooling system of a PWR nuclear reactor core is represented, namely the steam generator connected in a closed loop to an exchanger immersed in the cooling pool.

It is also to be pointed out that the dashed lines denote the electrical supply lines of the various electrical components, while the solid lines denote the fluidic lines.

FIG. 4 illustrates an autonomous system for removing at least a part at a time of the decay heat of a PWR according to the invention.

The system firstly comprises the cooling pool 5 arranged on the ground, a water condenser 4 immersed in the pool so that the water contained in the latter cools the steam coming from the secondary circuit of the reactor, and a first pump 30 for supplying the steam generator with water from the water condenser.

It also comprises an organic Rankine cycle (ORC) engine 6 comprising:
an expander 60;
a condenser 61,
a second pump, referred to as the ORC pump, which is a working fluid pump 62;
an evaporator 63 arranged relative to the pool 5 so that the latter constitutes the heat source of the ORC;
a fluidic circuit 64 in which a working fluid flows in a closed loop.

As illustrated, according to the invention the fluidic circuit 64 connects the expander 60 to the condenser 61, the condenser 61 to the pump 62, the pump 62 to the evaporator 63, and the evaporator 63 to the expander 60.

A second water reservoir forming a general pool 7 contains all of the heat sink dedicated to cooling the reactor, and supplies the pool 5 which is dedicated to the operation of the ORC and contains the safety condenser 4 and the ORC evaporator 63.

The water coming from the pool 7 is used as a heat sink for the exchanger condenser 61.

The water coming from the pool 7 is heated slightly by the condenser 61 before being injected into the pool 5 by means of a third pump 8, which is a water pump. This pump 8 supplies a dedicated fluidic line 65 for overcoming the evaporation of the pool 5 receiving the reactor decay heat.

The expander 60 may typically be a turbine, or a pressure reducer with coils, screws, pistons, etc.

The condenser 61 is typically a plate condenser.

The pump 62 is typically a centrifugal pump or membrane pump, screw pump, etc.

The engine 6 may comprise a buffer tank 66, that is to say a reservoir of a quantity of working fluid which in particular allows adequate operation of the ORC in a variable regime. As illustrated in FIG. 4, this buffer tank 66 may be arranged upstream of the pump 62.

In the embodiment illustrated in FIG. 4, the evaporator 63 is a tube evaporator immersed vertically in the pool 5.

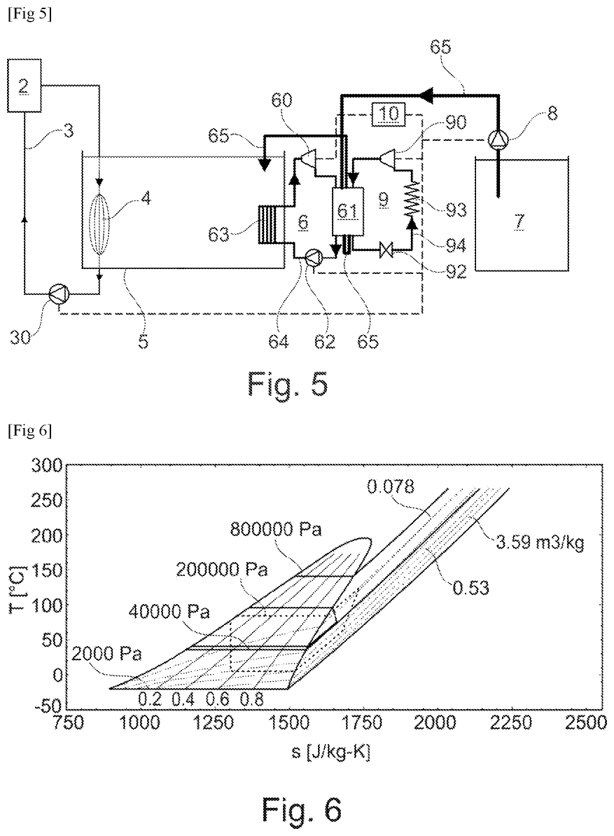

In the advantageous embodiment of FIG. 5, a refrigeration cycle 9 comprising the following is furthermore provided:
a compressor 90;
a condenser 61, which is that of the ORC, connected to the water pump 8 in order to supply it with water;
a pressure reduction member 92;
an air evaporator 93,
a fluidic circuit 94 in which a working fluid flows in a closed loop.

The fluidic circuit 94 connects the compressor 90 to the condenser 61, the condenser 61 of the ORC to the pressure reduction member 92, the pressure reduction member to the air evaporator 93, and the air evaporator 93 to the compressor 90.

The pressure reduction member 92 may be a valve, preferably a turbine, an ejector, etc.

Like the ORC 6, the refrigeration cycle 9 may also comprise a buffer tank forming a reservoir of working fluid in this cycle.

Batteries 10 may be provided for the electrical start-up of the various pumps 30, 62, 8, of the electrical components of the ORC and optionally of the refrigeration cycle 9. More precisely, the batteries may be used firstly to supply the pump 30 of the cooling circuit, then secondly, when the water reservoir 5 is boiling, to allow start-up of the ORC, that is to say start-up of the pump 62 and of the filling pump 8.

An example of dimensioning, according to an accident situation in the case of a PWR with a power of 3200 MWth, is provided below.

The working fluid of the ORC is an organic fluid, the evaporation temperature of which is lower than that of the boiling water by about 100° C. at atmospheric pressure. In particular, Novec649, HFE7000, HFE7100, etc. may be mentioned. Numerous other organic fluids may be envisioned, such as alkanes, HFC, HFO, HFCO, HFE, as well as some other fluids (NH₃, CO₂) and all mixtures thereof.

The fluid used in the dimensioning simulation is HFE7100, and it is advantageously used both in the ORC 6 and in the refrigeration cycle 9.

In this example, sensors of temperature or water level of the pool 5 make it possible to detect the state of complete saturation of the pool 5 and the start of the loss of liquid level by boiling. The indicated value of 50 m³ corresponds to a typical delay of 5 minutes of operation of a condenser removing 60 MW from the SG. At that moment, the pump 8 injects a flow rate corresponding exactly, by dimensioning, to replacement of the water evaporated in the pool 5, i.e. the evaporation produced by the 60 MW exchanged.

The pump 30 is regulated in flow rate in order to produce the 60 MW of heat exchange of the condenser 4, and the pumps 8 and 30 are thus linked by the power transfer function of the condenser 4, given that the boiling of 1 kilogram of water of the pool 5 requires about 2.25 MW of thermal power delivered by the condenser 4.

The dimensioning relating to the pool 5 and the water reservoir 7 is summarized in Table 1 below.

TABLE 1

| Dimension | Value |
|---|---|
| Total volume of the pool 5 | 50 m³ |
| Water reservoir 7 | as a function of |
| | the maximum |
| | autonomy of |
| | autonomous |
| | operation of the |
| | reactor |
| Height difference between | 30 m |
| the pool 5 and the steam generator 2 | |

The information relating to the operating time of the pool is summarized in Table 2 below.

TABLE 2

| Operation | Duration (min) |
|---|---|
| Pool 5 enters saturation | T0 + 5 |
| in a 60 MW condenser operating regime | |
| Start-up of the ORC | T0 + 5 + |
| | a few seconds |

The flow rates are given in the following Table 3:

TABLE 3

| Flow rate | Value (kg/s) |
|---|---|
| Flow rate of the working fluid of the ORC | 3.5 |
| Flow rate of pumped water (heat sink) | 30 |
| Flow rate of the working fluid of the | 0.2 |
| refrigeration cycle dedicated to the ORC | |

The correspondence between the flow rates of the pumps 8 and 30 will now be indicated.

In this dimensioning example, the condenser 61 without subcooling of the condensates is operated at a power of 60 MWth by the command control of the plant, which stipulates reactor cooling by x degrees/h at an SG steam pressure of 60 bar.

The flow rate of the pump 30 is equal to the ratio between the power and the latent heat at saturation under 60 bar, that is to say equal to 60 MW/1.57 MJ/kg, i.e. 38.2 kg/s. That is to say a volume flow rate of the pump 30 of 180 m³/h.

Considering a pump output overpressure of 3 bar to raise the condensates and the head losses in the circuit, this gives a hydraulic power of 15 kW, i.e. with a pump efficiency equal to 0.7, an electrical supply power of 22 kWe. The battery associated with the operation of the pump 30 therefore needs to be able to supply 22 kWe for at least 5 minutes, before the ORC steps in.

The flow rate, associated with this operating point, of the pump 8 is derived directly by the relationship: the flow rate of water pumped is equal to the ratio between the power and the latent heat at atmospheric pressure, that is to say equal to 60 MW/2.25 MJ/kg, i.e. 27 kg/s. The associated volume flow rate of the pump 8 is therefore about 100 m³/h. This pump needs to be battery-supplied for the start-up of the ORC (heat sink provisioning).

The external temperatures are given in the following Table 4:

TABLE 4

| Temperature | Value (° C.) |
|---|---|
| Average temperature of the heat source | 100 |
| Temperature of the heat sink | 30 |
| Temperature of the heat sink (output of the ORC) | 34 |

The internal pressures are given in the following Table 5:

TABLE 5

| Pressure | Value (bar) |
|---|---|
| High cycle pressure of ORC 6 | 2.4 |
| Low cycle pressure of ORC 6 | 0.45 |

The powers of the exchangers are given in the following Table 6:

TABLE 6

| Powers | Value (kW) |
|---|---|
| Power of ORC condenser (61) | 600 |
| Power of ORC evaporator (63) | 550 |

The electrical powers are given in the following Table 7:

TABLE 7

| Electrical powers | Value (kW) |
|---|---|
| Power of ORC pump (62) | 1.4 |
| Power of water pump (8) | 0.6 |
| Power of water pump (30) | 33 |
| Power of electrical turbine (60) | 35 |

Thus, under all these operating conditions, the volume of the exchangers to be dimensioned is summarized in the following Table 8:

TABLE 8

| Volumes | Value (m³) |
|---|---|
| Volume of ORC condenser (HFE7100/water) | 0.02 |
| Volume of ORC evaporator (HFE7100/water) | 3.66 |

The T-s diagram of the ORC and the refrigeration cycle is shown in FIG. 6.

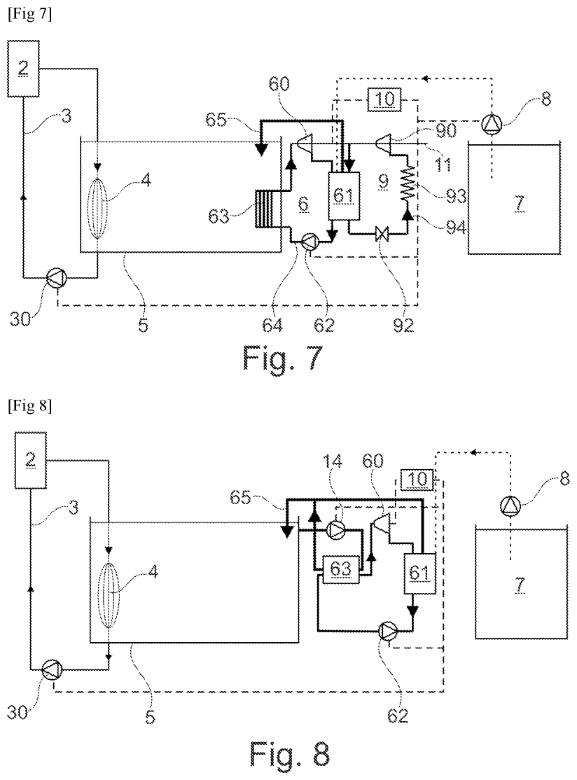

One of the possible variants of the configuration according to FIG. 5 consists in coupling the shaft 11 of the turbine 60 of the ORC 6 and the shaft of the compressor of the refrigeration cycle. This configuration, which is shown in FIG. 7, makes it possible to avoid the need for electrically supplying the compressor of the refrigeration cycle, and thus makes it possible to save on energy (electromechanical conversions).

A second variant of the system consists in sharing more components between the ORC and the refrigeration cycle: the working fluid, a part of the pipework, the condenser 61, as already illustrated.

Another possible variant is not to use an immersed tube evaporator as shown in FIG. 4 but instead a remote evaporator, for example of the plate type. In order to do this, it is necessary to convey water from the reservoir in a conduit via a pump 14, as shown in FIG. 8. This configuration makes it possible to reduce the volume of the hot exchanger, to reduce the workload for installing the exchanger on the pool, or allows the possibility, as in the previous configuration, of operating the ORC by using an ancillary heat source. It should be noted that returning the water at the exit of the evaporator while mixing it with that coming from the ORC condenser means that only a single tap from the pool is needed, instead of two in the other variants and configurations.

The invention is not limited to the examples which have just been described; in particular, characteristics of the examples illustrated may be combined with one another within variants which are not illustrated.

Other variants and embodiments may be envisioned without thereby departing from the scope of the invention.

The DHR system which has just been described in connection with a pressurized water nuclear reactor may equally be implemented in a boiling water nuclear reactor (BWR).

In general, the invention applies to any pool 5 which can constitute the heat sink intended for cooling a PWR core or a BWR core, or for cooling and/or depressurizing the primary containment building of a PWR or of a BWR.

Thus, in the examples illustrated, the means for removing the decay heat coming from the core of the reactor passes through the steam generator, and this means may equally well be a condenser installed in the containment building whether for a PWR or for a BWR.

For a PWR, for example, reference may be made to the configuration of the ambience condenser panels of the HPR1000 project (“Passive containment heat removal”) or to publication [6], which describes an optimized condenser mounted against the containment building wall (“Passive containment cooling system”). For a BWR, reference may be made to the configuration of the KERENA advanced reactor of the cooling condensers (“Containment cooling condensers”) of the building.

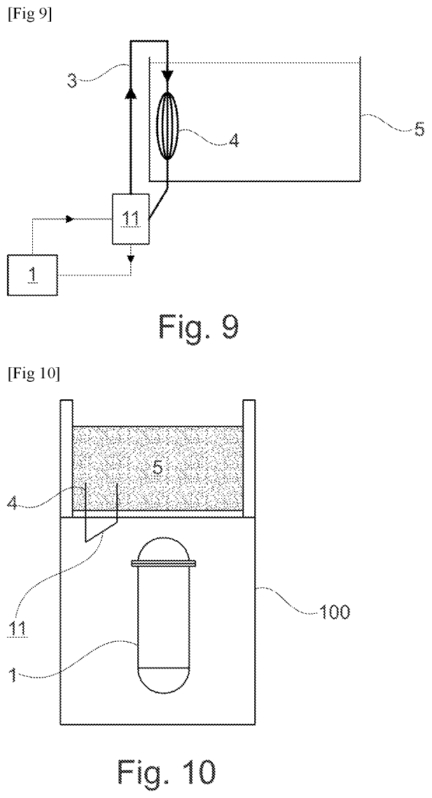

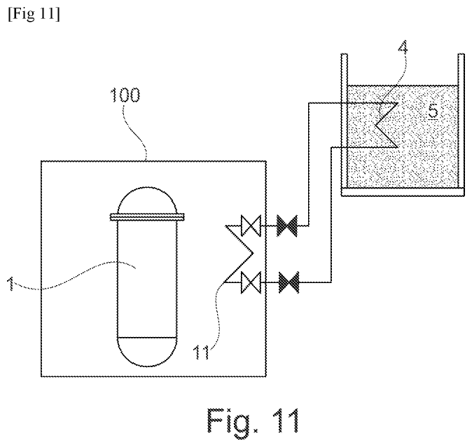

More generally, for a PWR or a BWR, the means for removing the decay heat coming from the core of the reactor may be a system for depressurizing the steam present in the containment building (FIG. 9), and the heat exchange means may be a water exchanger 4 immersed in the pool 5 (closed-loop configuration of FIG. 11, taken from reference [6]) or a direct take-off of the water of the pool 5 (closed-loop configuration of FIG. 10, taken from reference [6]) on the one hand, and a “containment wall condenser” 11 in direct contact with the steam present in the containment building 100 of the reactor on the other hand.

The pool 5 may be the supply source of a spray header of a containment spray (CS) circuit which, in the event of an accident leading to a significant increase in the pressure in the building of the reactor, makes it possible to reduce this pressure and thus preserve the integrity of the containment building. For a PWR, reference may be made to the configuration of spray headers internal to the primary containment building of the HPR 1000 project or external to the primary containment of the AP1000 project.

The pool 5 may be an overpressure pool of a BWR, for example a torically shaped steel pool in a Mark I type reactor, the water steam accidentally coming from the core of the reactor being condensed.

The pool 5 may also be a pool of the security injection circuit of a PWR, such as that of the HPR-1000 project, with the acronym IRWST (“In containment Refueling Water System Tank”).

### LIST OF REFERENCES CITED

[1]: https://www-pub.iaea.org/MTCD/Publications/PDF/TE-1785_web.pdf.
[2]: S. Kadalev et al., 2014, Annals of Nuclear Energy, vol. 72, p. 182-188;
[3]: D. C. Sun, Y. Li, Z. Xi, Y. F. Zan, P. Z. Li, W. B. Zhuo, “Experimental evaluation of safety performance of emergency passive residual heat removal system in HPR1000”, Nuclear Engineering and Design, Volume 318, 2017, Pages 54-60, ISSN 0029-5493, https://doi.org/10.1016/j.nucengdes.2017.04.003.
[4]: Mikhail Maltsev, 2015, “Additional information on modern VVER Gen III technology” https://www.oecd-nea.org/upload/docs/application/pdf/2020-07/ii-1a-maltesev.pdf
[5]: David Hinds and Chris Maslak, “Next-generation nuclear energy: The ESBWR” Nuclear News. January 2006.
[6]: https://www-pub.iaea.org/MTCD/Publications/PDF/te_1624_web.pdf

1. A light water nuclear reactor (LWR), comprising:
a reactor core;
a cooling circuit comprising a heat exchange device connected in a closed loop to a take-off device for taking off steam from the primary or secondary circuit of the reactor and a first pump for supplying the take-off device of the primary or secondary circuit with water from the heat exchange device;
a system for removing at least a part of the decay heat of the reactor core, the system comprising:
a first water reservoir or pool, arranged below the steam generator, wherein the heat exchange device is immersed so that the water contained therein cools the steam coming from the take-off device;
an organic Rankine cycle (ORC) engine comprising:
an expander;
a condenser,
a second pump;
an evaporator arranged in contact with the pool so that the latter constitutes the heat source of the ORC;
a fluidic circuit wherein a working fluid flows in a closed loop, the fluidic circuit connecting the expander to the condenser the condenser to the second pump, the second pump to the evaporator, and the evaporator to the expander;
a second water reservoir, separate from the pool, and a third pump connected to the second water reservoir and to the condenser of the ORC in order to supply the latter with water, as the heat sink of the ORC.

2. The water nuclear reactor according to claim 1, comprising a cooling circuit comprising a steam generator and a water condenser immersed in the pool and connected in a closed loop to the steam generator.

3. The water nuclear reactor according to claim 1, the device for withdrawing the decay heat present in the primary circuit being a liquid/liquid exchanger, and the heat exchange device being a water exchanger immersed in the pool, so that the water contained in the latter cools the water of the primary circuit flowing in the liquid/liquid exchanger.

4. The water nuclear reactor according to claim 1, comprising a cooling circuit comprising:
a take-off of primary steam from the supply line to the turbine of the reactor;
a water condenser immersed in the pool and connected in a closed loop to the steam take-off.

5. The water nuclear reactor according to claim 1, the device for removing the decay heat coming from the core of the reactor being a system for depressurizing the steam present in the containment building, and the heat exchange device being a water exchanger immersed in the pool or a direct take-off of the water of the pool on one hand, and on the other hand a containment wall condenser in direct contact with the steam present in the containment building of the reactor.

6. The nuclear reactor according to claim 1, the first water reservoir or pool being arranged on or in the ground.

7. The nuclear reactor according to claim 1, the second water reservoir being arranged on or in the ground.

8. The nuclear reactor according to claim 1, the evaporator being immersed in the pool or remote therefrom.

9. The nuclear reactor according to claim 8, the immersed evaporator being a tube exchanger.

10. The nuclear reactor according to claim 8, the immersed evaporator being a plate exchanger.

11. The nuclear reactor according to claim 1, furthermore comprising a refrigeration cycle comprising:
a compressor;
a condenser connected to the third pump in order to supply the latter with water;
a pressure reduction member;
an air evaporator,
a fluidic circuit wherein a working fluid flows in a closed loop, the fluidic circuit connecting the compressor to the condenser, the condenser to the pressure reduction member, the pressure reduction member to the air evaporator, and the air evaporator to the compressor.

12. The nuclear reactor according to claim 11, the condenser of the refrigeration cycle being the condenser of the ORC.

13. The nuclear reactor according to claim 11, the working fluid of the refrigeration cycle being that of the ORC.

14. The nuclear reactor according to claim 11, the shaft of the ORC expander being coupled to the shaft of the compressor of the refrigeration cycle.

15. The nuclear reactor according to claim 1, comprising an injector arranged in a lower part of the system and connected to the third pump arranged in an upper part of the system, the injector being configured to prime the third pump.

16. The nuclear reactor according to claim 1, comprising batteries configured for the electrical start-up of the pumps, of the electrical components of the ORC and optionally of the refrigeration cycle.
